(19) United States
(12) Patent Application Publication
(10) Pub. No.: US 2013/0166312 A1
(43) Pub. Date: Jun. 27, 2013

(54) SYSTEM AND METHOD FOR TOOTH SELECTION AND ORDER GENERATION

(71) Applicants: Frank LAUCIELLO, Elma, NY (US); Michael GAGLIO, East Amherst, NY (US)

(72) Inventors: Frank LAUCIELLO, Elma, NY (US); Michael GAGLIO, East Amherst, NY (US)

(21) Appl. No.: 13/336,230

(22) Filed: Dec. 23, 2011

(51) Int. Cl. G06Q 50/22

(52) U.S. Cl. 705/2

(57) ABSTRACT

The present invention may be embodied as a method or a system for generating an order for a dental restoration of an individual. An automated tooth selection apparatus is disclosed, comprising an image capture device and a processor. The automated tooth selection apparatus is configured to capture range data for each captured image, wherein the range data corresponds to the distance between the image capture device and the individual. An image is captured of a facial feature of the individual using the image capture device. The processor is used to determine the size of the facial feature of the individual. A tooth for the dental restoration of the individual is selected from a database of available teeth based on the determined size of the facial feature. An order for a dental restoration is generated including the selected tooth.

### FIELD OF THE INVENTION

The invention relates to dental restoration, and more particularly to systems and methods for computer-guided selection of teeth and/or teeth molds for dental restoration and case planning.

### BACKGROUND OF THE INVENTION

Previous inventions have offered kits to assist a dentist or technician in selecting a tooth for a dental restoration of an individual. For example, U.S. Pat. No. 7,128,572, to Lauciello et al., the disclosure of which is incorporated herein by reference, discloses a kit for selecting denture teeth by relating the tooth size to the size of a facial feature of the individual. Numerous investigators have suggested a correlation between the intercanine distance and the interalar width of the nose. Investigators recorded the interalar width of the nose with an instrument, and then placed the pointers of the instrument against the natural maxillary canines. They found that, in 75% of their subjects, the pointers indicated approximately the center areas of the canines. This investigation resulted in the development of the Swissedent® Alameter.

Boucher suggested projecting perpendicular lines downward from the alae of the nose to the buccal surface of a maxillary occlusion rim in the mouth. Marks are made on the occlusion rim, and the marks are used to position the tips or distal edges of the artificial canines. To select an appropriate size of an artificial tooth, the distance between the canine marks is measured around the curve of the occlusion rim with a flexible rule. Six maxillary anterior teeth are chosen with an over-all width equal to this measurement. Further investigation of this relationship was mathematically analyzed to more accurately determine maxillary anterior mold selection. Drs. Fisher and Frush introduced the concept of Dentogenics to the profession. Dentogenics is a concept that suggests various alterations of tooth morphology and position of teeth that follows individual patient characteristics (sex, personality, age). Tooth molds with feminine attributes were typified by gentle, rounded features, which suggest softness and smoothness. Conversely masculine tendencies were characterized in dentogenics by robust, cuboidal forms that expressed strength, vigor, and boldness. The organization of anterior mold morphology according to “softness” and “boldness” is a generally accepted classification of anterior tooth morphology and is commonly used in the tooth selection process.

However, previous systems were manual in nature and required the dentist or technician to measure and select teeth separate from the remainder of the ordering process. Accordingly, there is a need for an automated method for selecting teeth and generating an order.

### BRIEF SUMMARY OF THE INVENTION

The present invention may be embodied as a method for generating an order for a dental restoration of an individual comprising the step of providing an automated tooth selection apparatus. The automated tooth selection apparatus comprises an image capture device configured to capture images of the individual, and a processor in electronic communication with the image capture device. The automated tooth selection apparatus is configured to capture range data for each captured image, wherein the range data corresponds to the distance between the image capture device and the individual.

The method further comprises the step of capturing an image of a facial feature of the individual using the image capture device. The processor is used to determine the size of the facial feature of the individual. A tooth for the dental restoration of the individual is selected from a database of available teeth based on the determined size of the facial feature. Once a tooth is selected, an order for a dental restoration is generated. The order includes at least the selected tooth. Other information may be gathered and included within the generated order. The order may be, for example, a prescription.

The present invention may also be embodied as a system for generating an order for a dental restoration of an individual, comprising an image capture device configured to capture images of the individual, and a processor in electronic communication with the image capture device. The automated tooth selection apparatus is configured to capture range data for each captured image, wherein the range data corresponds to the distance between the image capture device and the individual.

The system further comprises a database of available teeth. The database may be stored “locally”—on a storage device (not shown) of the automated tooth selection apparatus. The database may be stored “remotely”—in a storage device of, for example, a server computer.

The processor of the automated tooth selection apparatus is programmed to perform the steps of the methods described herein. For example, the processor is programmed to determine the size of a facial feature of the individual. The processor is further programmed to select a tooth from the database based on at least the determined size of the facial feature. The processor is programmed to generate an order for a dental restoration including the selected tooth.

The present invention may be embodied as a computer-readable medium containing program instructions for generating an order for a dental restoration of an individual. The program is configured for execution on an automated tooth selection apparatus similar to those described above and further described herein. Execution of the program instructions by the processor of the automated tooth selection apparatus causes the processor to carry out the steps of any of the methods described herein.

The automated tooth selection apparatus may be a tablet computer or a smartphone having a camera. For example, the automated tooth selection apparatus may be a Apple® iPad® 2. In this example, the present invention may be a computer-readable medium containing program instructions for causing an Apple® iPad® 2 to perform the steps of any of the methods above. The range data may be embodied as described above; for example, the range data may be an image of a calibration object located proximate to the individual.

### DESCRIPTION OF THE DRAWINGS

For a fuller understanding of the nature and objects of the invention, reference should be made to the following detailed description taken in conjunction with the accompanying drawings, in which:

FIG. 1 is a flowchart depicting methods according to embodiments of the present invention;

FIG. 2A is a flowchart depicting exemplary sub-steps in the step of selecting a tooth;

FIG. 2B is a flowchart depicting other exemplary sub-steps in the step of selecting a tooth;

FIG. 2C is a flowchart depicting other exemplary sub-steps in the step of selecting a tooth;

FIG. 2D is a flowchart depicting other exemplary sub-steps in the step of selecting a tooth;

FIG. 2E is a flowchart depicting exemplary sub-steps in the step of generating an order;

FIG. 3A depicts an individual and a system according to an embodiment of the present invention wherein the range data is obtained using a calibration object;

FIG. 3B depicts a side view of the matter of FIG. 3A

FIG. 4 depicts an individual and a system according to another embodiment of the present invention wherein the range data is obtained using a target projector;

FIG. 5 depicts an individual and a system according to another embodiment of the present invention wherein the range data is obtained using a rangefinder;

FIG. 6 depicts an individual and a system according to another embodiment of the present invention wherein the range data is obtained using a calibration poster;

FIG. 7 is a display screen from an exemplary embodiment of the present invention showing a prompt for the operator to select an existing plan;

FIG. 8 is a display screen from an exemplary embodiment of the present invention showing a prompt for the operator to identify the extents of the width of the patient's nose;

FIG. 9 is a display screen from an exemplary embodiment of the present invention showing a prompt for the operator to select between a fixed restoration or a removable restoration;

FIG. 10 is a display screen from an exemplary embodiment of the present invention showing a prompt for the operator to select a product line;

FIG. 11 is a display screen from an exemplary embodiment of the present invention showing a prompt for the operator to select a tooth location; and

FIG. 12 is a flowchart of an exemplary method according to an embodiment of the present invention.

### DETAILED DESCRIPTION OF THE INVENTION

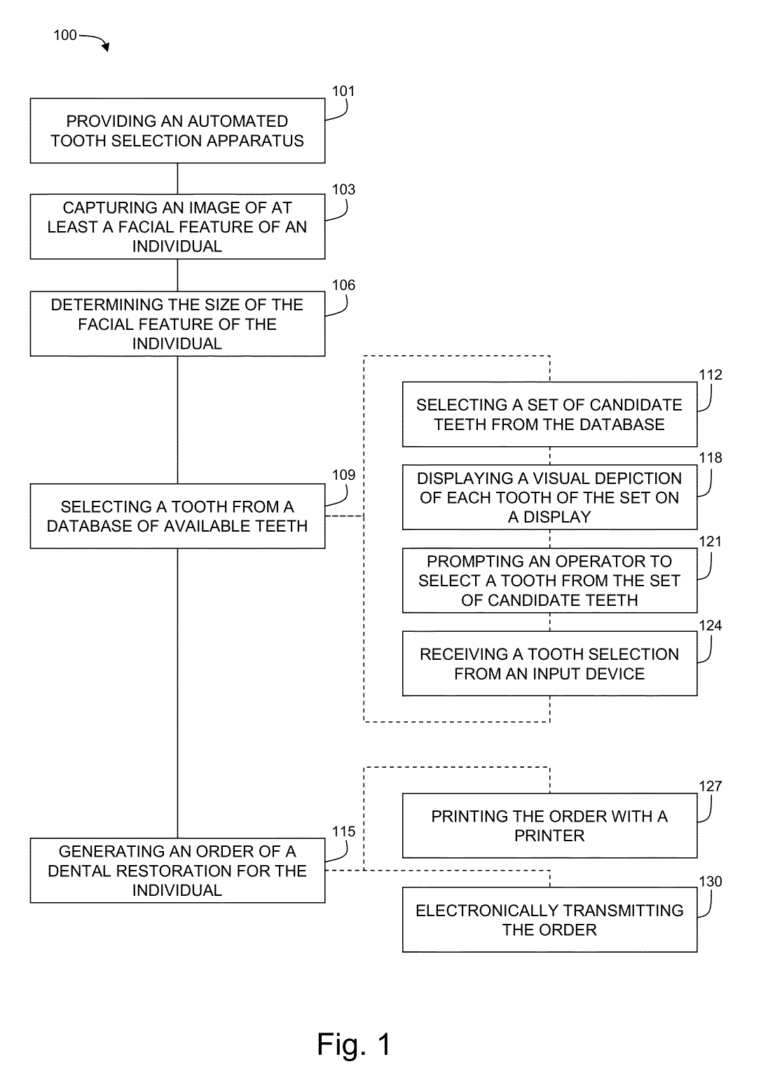

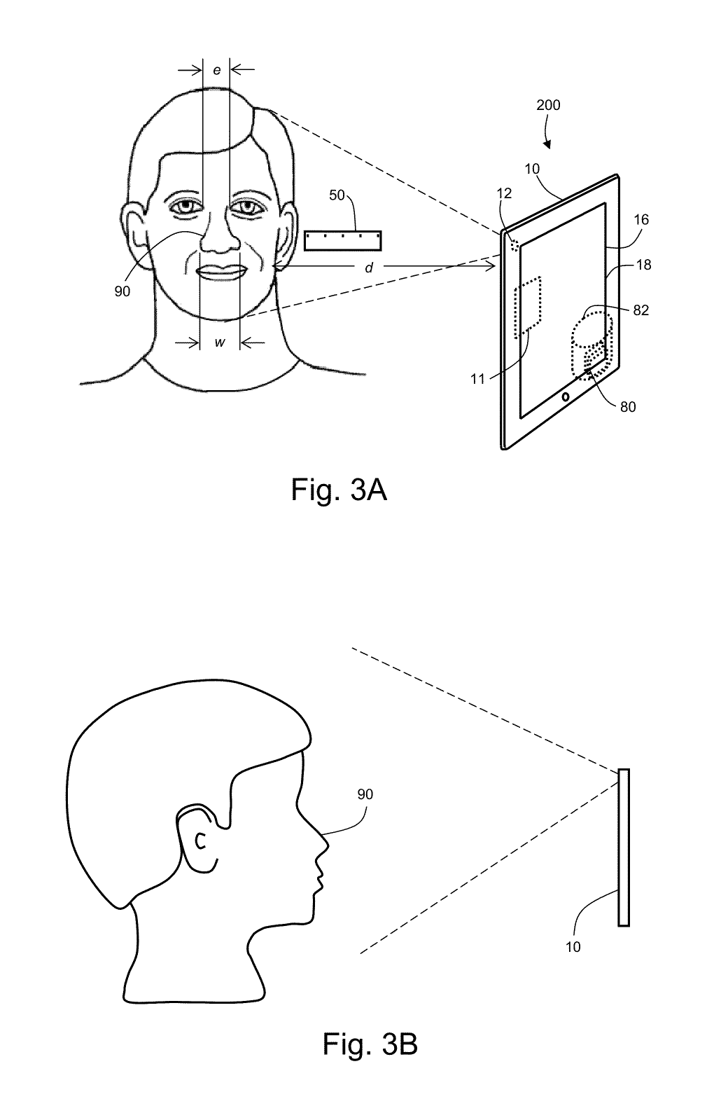

The present invention may be embodied as a method 100 for generating an order for a dental restoration including, but not limited to, denture teeth for an individual. FIG. 1 is a flowchart of one such method. It should be noted that the term “order” as used herein has a broad meaning that includes at least prescriptions, purchase orders, case plans, and any other ways of describing the dental restorative needs of an individual. In the method 100, an automated tooth selection apparatus 10 is provided 101. FIGS. 3A and 3B depicts aspects of one such automated tooth selection apparatus 10. It should be noted that the term “tooth” as used herein has a broad meaning that includes at least a tooth mould.

The automated tooth selection apparatus 10 comprises an image capture device 12. The image capture device 12 is configured to capture images of the individual 90. More specifically, the image capture device 12 may be used to capture an image of a facial feature of the individual 90. The image capture device 12 may be a still camera, a video camera, or any other device for capturing images. The images may be captured in any range of the light spectrum including without limitation, visible and infrared light. The automated tooth selection apparatus 10 further comprises a processor 11. The processor 11 is in electronic communication with the image capture device 12. In this way, the processor 11 can receive and act on an image captured by the image capture device 12.

The facial feature may be the individual's nose, or more specifically the interalar width w of the individual's nose. The facial feature may be the distance e between the inner canthi of the individual's eyes. The disclosure is made with reference to the interalar distance, but it should be noted that the facial feature may be any feature that can be correlated to the size of the individual's teeth.

The automated tooth selection apparatus 10 is configured to capture range data for each captured image. The range data corresponds to the distance d between the image capture device 12 and the individual. The distance d between the individual 90 and the image capture device 12 may be obtained directly or indirectly from the range data as described more fully in the exemplary range data embodiments infra.

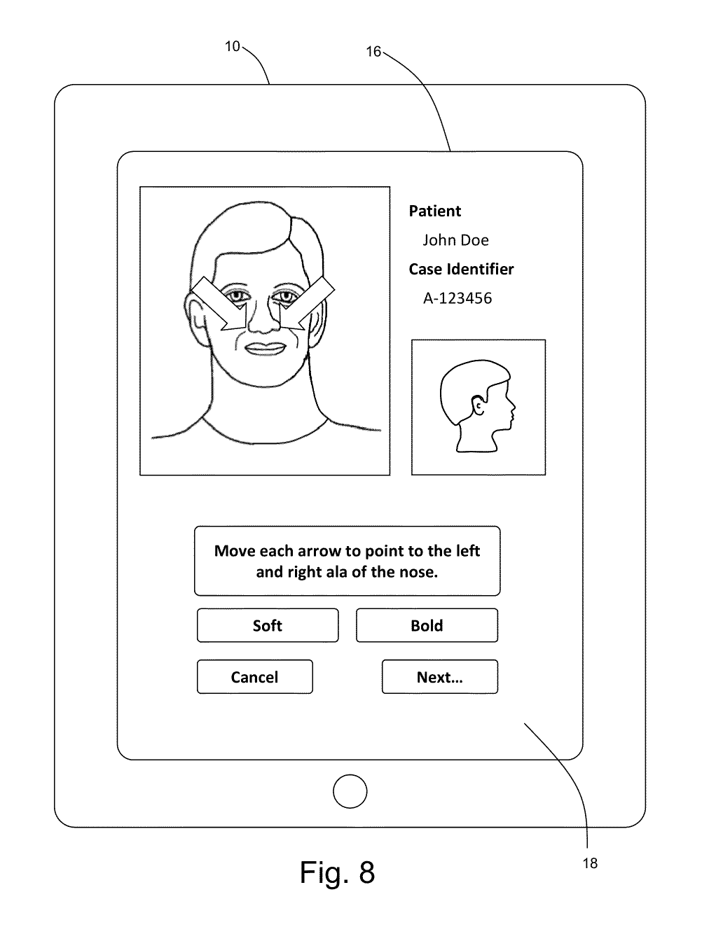

The method 100 further comprises the step of capturing 103 an image of the nose of the individual 90 using the image capture device 12 of the automated tooth selection apparatus 10. The operator may be prompted to identify the extents of the width of the nose (see, e.g., FIG. 8). And, the processor 11 is used to determine 106 the width w of the nose of the individual 90. The width w is determined using the captured image and the range data. For example, when the range data is a calibration object 50 (more fully described below), the width w may be calculated by comparing the ratio of the imaged size of the calibration object 50 and the actual size of the calibration object 50. This ratio is then applied to the width of the nose in the image (image width) to determine the actual width w of the nose of the individual, as in:

$$Actual Size of Facial Feature = \frac{Actual Size of the Calibration Object}{image Size of the Calibration Object} * Image Size of Facial Feature$$

A tooth appropriate for the dental restoration of the individual 90 is selected 109 from a database of available teeth. The database 80 may be local to the automated tooth selection apparatus 10—e.g., stored on a storage device 82 of the automated tooth selection apparatus 10. The database 84 may be remote from the automated tooth selection apparatus 10—e.g., stored on a storage device 86 of a server computer accessible over a network. The tooth is selected 109 based on at least the size of the facial feature of the individual 90. In the case where the facial feature is the nose of the individual, the tooth may be selected 109 according to known relationships between tooth size and nose width. For example, the tooth may be selected 109 so that the size of the tooth relates to the width of the nose according to the known relationship between intercanine distance and the interalar width of the nose. In some embodiments, the tooth may be an anterior tooth. The tooth may be an upper anterior tooth.

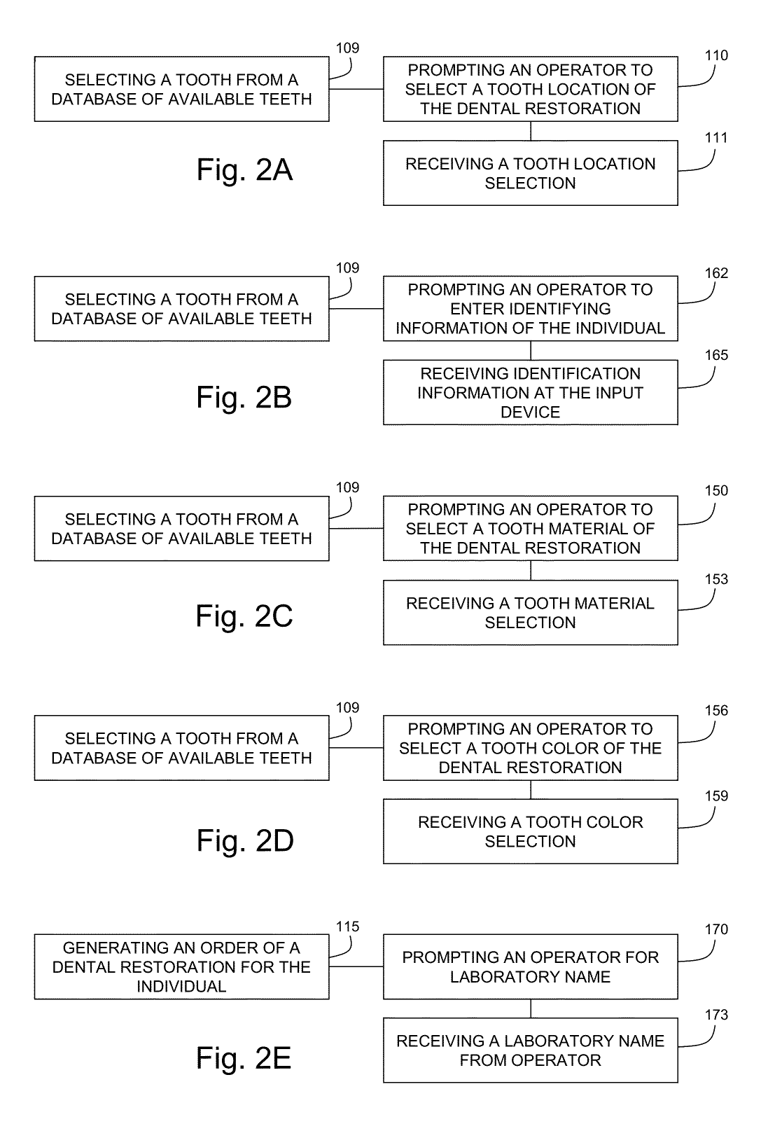

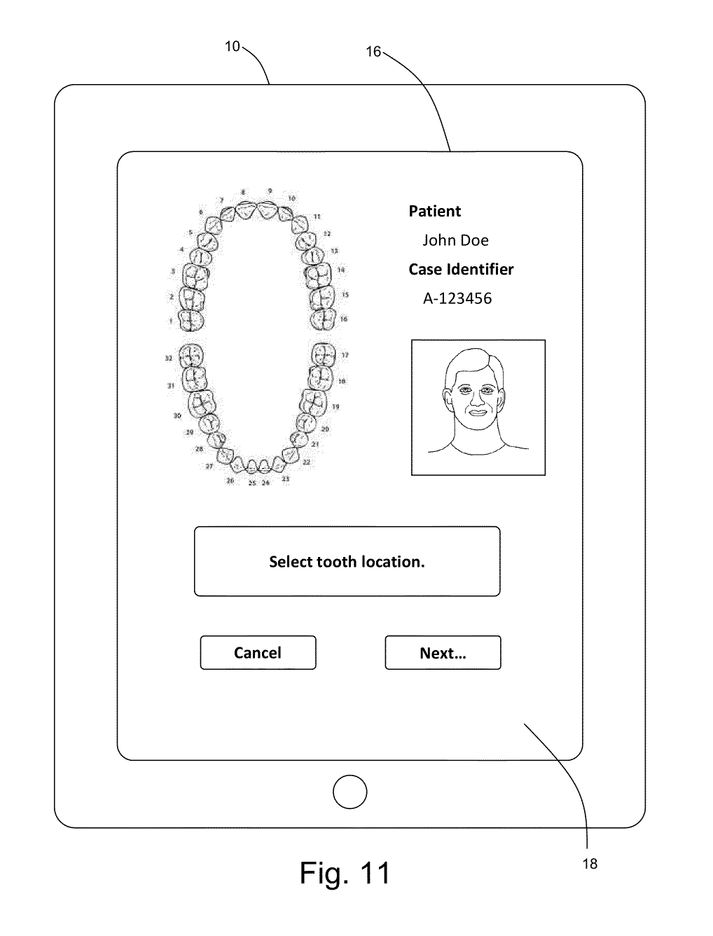

In selecting 109 a tooth for the dental restoration, the method 100 may further comprise the sub-step of prompting 110 an operator to select a tooth location for the restoration (see, e.g., FIG. 2A). The prompt may be visual (e.g., textual, pictorial, etc.), auditory (e.g., speech synthesis, etc.), or any other prompts commonly known. In an embodiment, the prompt is a pictorial depiction of the maxillary and mandibular arches of a human displayed on a display 16 of the automated tooth selection apparatus 10 (see, e.g., FIG. 11). The teeth of the pictorial depiction may be numbered according to a standard dental notation scheme (Universal numbering system, FDI World Dental Federation notation, Palmer notation, etc.) or otherwise labeled. Or, the teeth need not be labeled. The processor may receive 111 a tooth location selection from an input device 18 of the automated tooth selection apparatus 10. For example, the display 16 of the automated tooth selection apparatus 10 may be a touch screen input device 18. In such an embodiment, the operator (dentist, technician, etc.) may select a tooth from the set of candidate teeth by touching the tooth in the pictorial depiction of the arches. Other input devices are known and are contemplated within the scope of the present invention, such as, for example, computer mice, keyboards, microphones. Where the input device 18 is a keyboard, the selection may be made by entering the number of the tooth location according to the displayed dental notation.

In selecting 109 a tooth for the dental restoration, the method 100 may further comprise the sub-step of selecting 112 a set of candidate teeth from the database. More than one tooth of the database 80 of available teeth may be of the appropriate size according to the selection criteria (e.g., interalar width of the nose). The teeth may differ in other characteristics, for example, shape, boldness, etc. The set of teeth of the database 80 that meet the selection criteria may be referred to as the candidate teeth. The candidate teeth may be selected 112 automatically by the processor and a visual depiction of each candidate tooth may be displayed 118 on a display 16 of the automated tooth apparatus 10. The visual depiction may be stored in the database 80. All of the candidate teeth need not be displayed 118 on the display 16 simultaneously. The candidate teeth may be displayed 118 individually or in other subsets.

The candidate teeth may be displayed 118 by superimposing each candidate tooth on an image of the individual such that the candidate tooth may be viewed in situ (virtually) to better assist the operator and/or the individual in visualizing the final dental restoration. In this case, the captured image comprises an image of at least a portion of the dentition of the individual. In other embodiments, additional images are captured for such virtual depictions.

Once a set of candidate teeth is selected 112 and displayed 118, the operator of the automated tooth selection apparatus may be prompted 121 to select a tooth from the set of candidate teeth. The prompt may be visual (e.g., textual, pictorial, etc.), auditory (e.g., speech synthesis, etc.), or any other prompts commonly known. The processor may receive 124 a tooth selection from an input device 18 of the automated tooth selection apparatus 10. For example, the display 16 of the automated tooth selection apparatus 10 may be a touch screen input device 18. In such an embodiment, the operator (dentist, technician, etc.) may select a tooth from the set of candidate teeth by touching the visual depiction of the desired tooth on the display 16. Other input devices are known and are contemplated within the scope of the present invention, such as, for example, computer mice and keyboards. The input device 18 is in electronic communication with the processor. As such, the processor may receive 124 the selection made at the input device 18.

Once a tooth is selected 109, an order is generated 115. As previously stated, the order may be a prescription, a purchase order, a case plan, or otherwise (or combinations, for example, a prescription and a purchase order from a laboratory). The order may be generated 115 by printing 127 the order to a printer. In another embodiment, the order may be generated 115 by electronically transmitting 130 the order to a laboratory. Orders may be required to have a particular format. For example, where the order is a printed paper prescription, requirements for the needed information may be pre-determined as to scope (what data is needed for a prescription) and format (where that data is printed on a paper prescription. Similarly, where the order is an electronic transmission, the scope and format of the electronic transmission is typically pre-determined. Therefore, the data collected for the order is formatted for the order. The data collected for the generated order is at least the selected 109 tooth.

Generating 115 the order may further comprise the sub-steps of prompting 170 the operator for a laboratory name (see, e.g., FIG. 2E). The laboratory name may be selected from a pre-determined list (e.g., a list of the recent laboratories used by the operator). The laboratory name may be entered by the operator and received 173. The operator may be prompted 170 to enter the contact information for the laboratory. For example, for a printed prescription, the laboratory's address may be entered. For an electronically transmitted prescription, the email address of the laboratory may also be provided. Where the laboratory name is selected from a pre-determined list, the operator may be prompted to confirm the laboratory contact information.

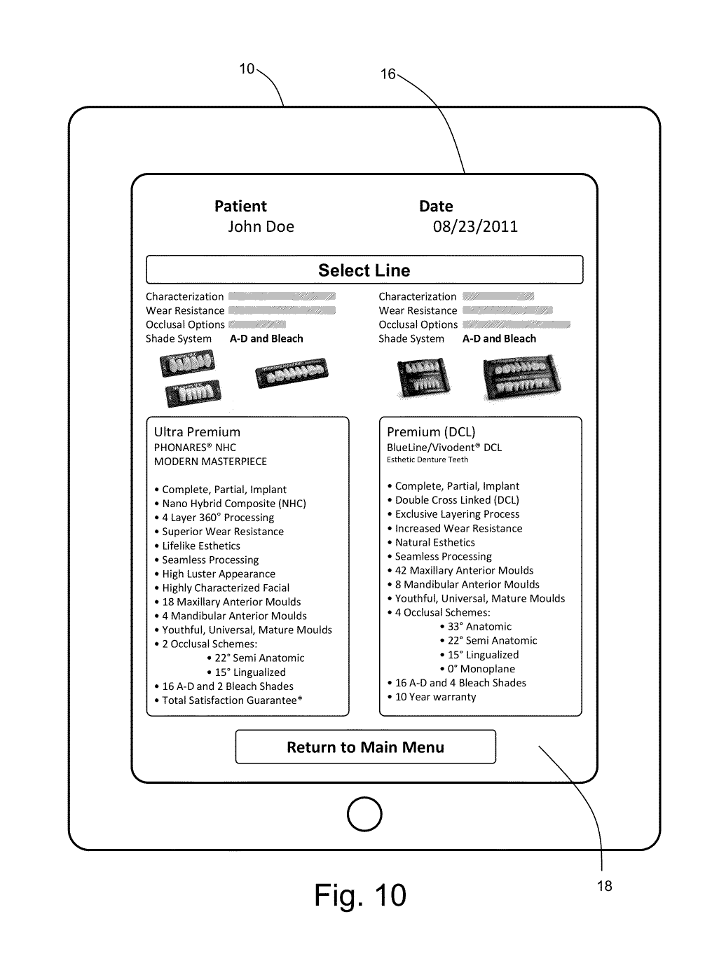

The method 100 may include additional steps to collect additional data related to the dental restoration. The method 100 may further comprise the step of prompting 150 the operator to select a tooth material from a set of available tooth materials (see, e.g., FIG. 2B). The set of available tooth materials may be stored in a database. The tooth materials may be different compositions or materials used in the manufacture of dental restorations, such as polymethylmethacrylate or composite resin materials used in the manufacture of denture teeth. The processor receives 153 the tooth material selection from the input device 18. FIG. 10 depicts an example of a tooth material selection screen where the operator is prompted to select from two product lines.

The method 100 may further comprise the step of prompting 156 the operator to select a tooth color from a set of available tooth colors (see, e.g., FIG. 2D). The set of available tooth colors may be stored in a database. The set of available tooth colors may be a sub-set of total tooth colors which have been filtered according to the tooth material selected above (certain tooth colors are not available with certain tooth materials. The processor receives 159 the tooth color selection from the input device 18. The tooth color may comprise multiple tooth colors (or shades) selected to produce a desired final tooth color. Other tooth characteristics such as, for example, color gradations, shades, and tooth opacity/translucency are included herein under the term “tooth color.”

The method 100 may further comprise the step of prompting 162 the operator to enter indentifying information of the individual 90 (see, e.g., FIG. 2A). Such indentifying information may include, for example, First Name, Last Name, unique case identification (file identification, record identification, patient identification, etc.), age, gender, address, telephone number, email address, dental insurance information, name of insured person, relation to insured person, and/or employer name. The processor receives 165 the identifying information from the input device 18.

The order generated 115 by the method 100 includes the selected tooth and may include any or all of the data collected above (e.g., tooth location, tooth material, tooth color, identifying information). The order may also include additional information not described above. For example, the order may include the name and contact information for the operator generating 115 the order.

The present invention may be embodied as a system 200 for generating an order for a dental restoration of an individual 90 (see, e.g., FIGS. 3A and 3B). The system 200 comprises an automated tooth selection apparatus 10 similar to any of the embodiments described above. For example, the automated tooth selection apparatus 10 comprises an image capture device 12 and a processor 11 in electronic communication with the image capture device 12. The image capture device 12 is configured to capture images of the individual 90 and range data corresponding to the distance between the image capture device 12 and the individual 90. The range data is further described below.

The system further comprises a database 80 of available teeth. The database 80 may be stored on a storage device 82 of the automated tooth selection apparatus 10. In this embodiment, the database 80 may be considered to be local 82 to the automated tooth selection apparatus 10. In another embodiment, the database 84 may be stored in a storage device 86 of, for example, a server computer. In this way, the database 84 may be considered to be remote from the automated tooth selection device 10.

The processor of the system is programmed to perform any of the method steps described above. In an embodiment, the processor is programmed to determine the size of a facial feature of the individual 90. For example, the processor may be programmed to determine the interalar width of the nose of the individual 90. The processor is further programmed to select a tooth from the database 80, 84 based on at least the determined size of the facial feature. The processor is programmed to generate an order for a dental restoration of the selected tooth.

The present invention may be embodied as a computer-readable medium containing program instructions for generating an order for a dental restoration of an individual. The program is configured for execution on an automated tooth selection apparatus similar to those described above. Execution of the program instructions by the processor of the automated tooth selection apparatus causes the processor to carry out the steps of any of the methods described above.

The automated tooth selection apparatus may be a tablet computer or a smartphone having a camera. For example, the automated tooth selection apparatus may be a tablet computing device, such as an Apple® iPad® 2. In this example, the present invention may be a computer-readable medium containing program instructions for causing a tablet computing device to perform the steps of any of the methods above. The range data may be embodied as described above; for example, the range data may be an image of a calibration object located proximate to the individual.

Range Data

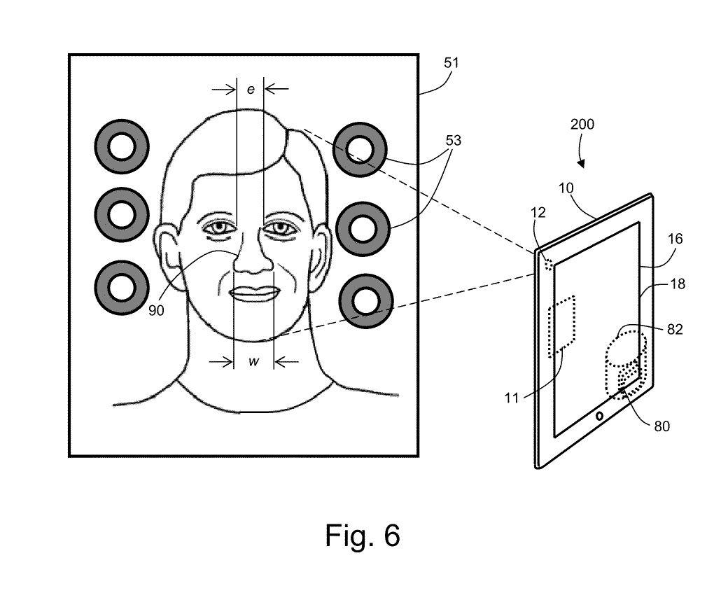

In an embodiment, the range data is an image of a calibration object 50. FIG. 3A depicts one such embodiment. The calibration object 50 has a known size and/or scale. For example, the calibration object 50 may be an object of known size. In another example, the calibration object 50 may have a known scale, for example, the calibration object 50 may be a ruler with gradations. FIG. 6 depicts another embodiment wherein the calibration object 51 is a poster having one or more targets 53. Other embodiments are possible and will be known to those with skill in the art. An image of the calibration object 50 is captured where the calibration object 50 is proximate to the individual 90, and preferably, the nose of the individual 90. The image of the calibration object 50 may be part of the image of the individual 90. In such a case, the range data is that portion of the image of the individual 90 which contains the image of the calibration object 50 proximate to the individual 90. The distance d may be determined through calculation of difference in the relative size of the calibration object 50 in the image and the actual size of the calibration object 50, taking into account the focal length and sensor height of the image capture device 12. For example:

$$Distance d = \frac{\begin{matrix}Focal Length * \\ Actual Size of Calibration Object * \\ Image Height\end{matrix}}{Image Calibration Object Size * Sensor Height}$$

The actual size of the facial feature of an individual may be measured using calibration object 50 range data to determine the distance d from the image capture device 12 to the individual (where the calibration object is placed proximate to the facial feature). In another method of calculating the actual size of the facial feature, the ratio of the actual size of the calibration object 50 to the image size of the calibration object 50 is used to calculate the actual size of the facial feature from the image size of the facial feature.

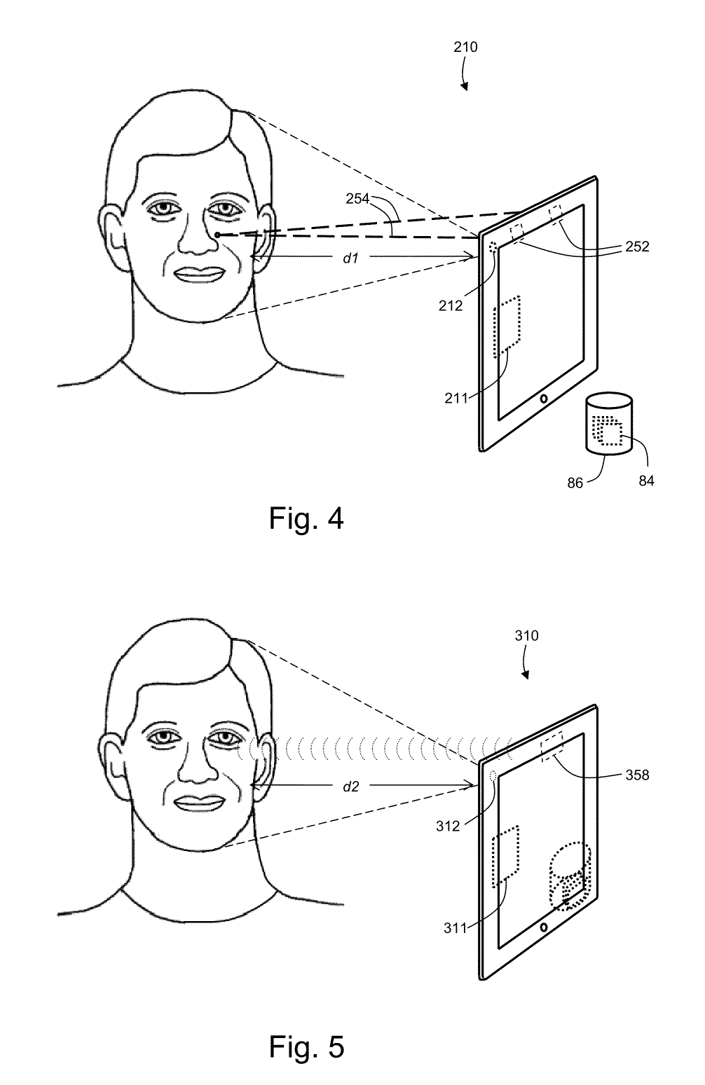

In another embodiment, the automated tooth selection device 210 further comprises a target projector 252. FIG. 4 depicts one system according this embodiment. The target projector 252 is configured to project at least two beams of light 254 to the individual. The beams of light 254 are configured to converge with one another when the image capture device 212 is located a pre-determined distance from the individual. In this way, the range data of an image of the individual is a known value—the predetermined distance d1.

In another embodiment depicted in FIG. 5, the automated tooth selection apparatus 310 further comprises a rangefinder 358 for determining the distance d2 from the image capture device 312 to the individual. The rangefinder 358 may be of any type known in the art using, for example, energy reflected off of a surface of the individuals. For example, the rangefinder 358 may utilize ultrasonic, laser, or other forms of energy. The rangefinder 358 is attached to the automated tooth selection apparatus 310 and is in electronic communication with the processor 311.

In another embodiment, the image capture device further comprises an integrated rangefinder. Many image capture devices, for example cameras, include rangefinding capabilities for the purposes of focusing the image for capture. In these cases, the image capture device may record the distance d3 to the individual. For example, many modern cameras record captured images following the Exchangeable Image File Format (“EXIF”), which includes image data and image metadata (data about the image data). Image capture devices that include integrated rangefinders often record the distance d3 in the EXIF image metadata.

Size Determination

Once the distance to the individual is known from the range data, the size of the facial feature may be calculated as follows:

$$Actual Size of Facial Feature = \frac{Distance d * Image Size of Facial Feature}{Focal Length}$$

The image size of the facial feature may be derived automatically through the use of image recognition algorithms. In another embodiment, the image size of the facial feature may be determined based on input from the operator on the input device (see, e.g., FIG. 8). In the embodiment where the automated tooth selection apparatus is a tablet computing device, the captured image may be displayed on the display. The operator may select at least two points on the facial feature to be measured. For example, the operator may select the extents of the interalar width. The apparatus may then calculate the distance between the selected points.

Databases

One having skill in the art will recognize that any databases described herein may be combined into one or more databases or may be individual databases. Where there is more than one database, the databases need not be stored in the same location. Therefore, the databases can be local or remote to any apparatus described herein according to the design goals of the particular embodiment.

Exemplary Method

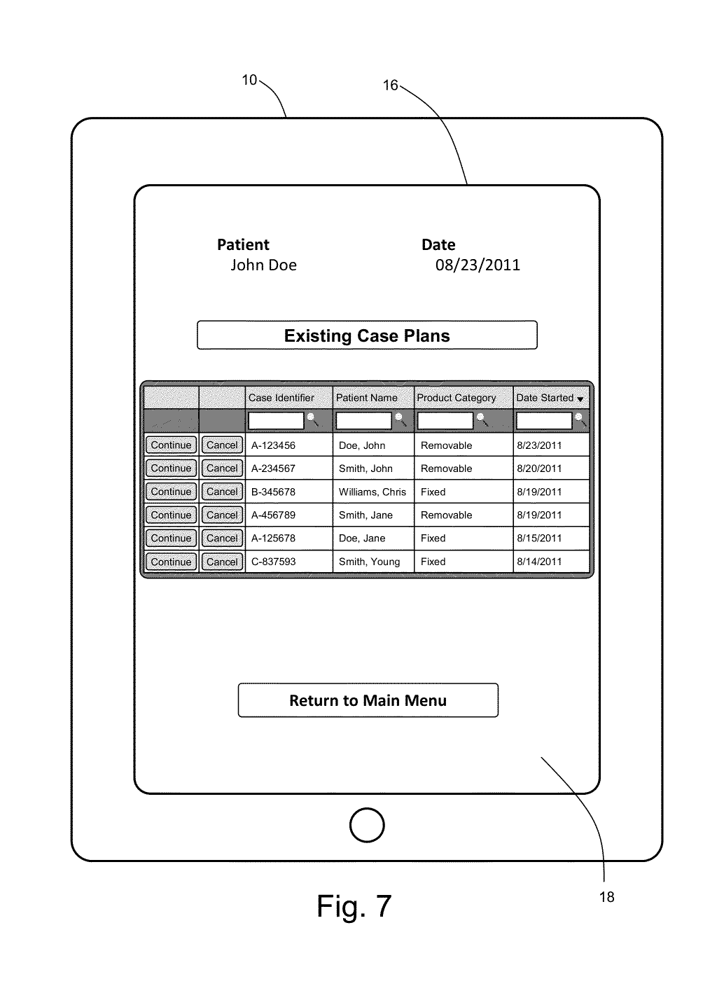

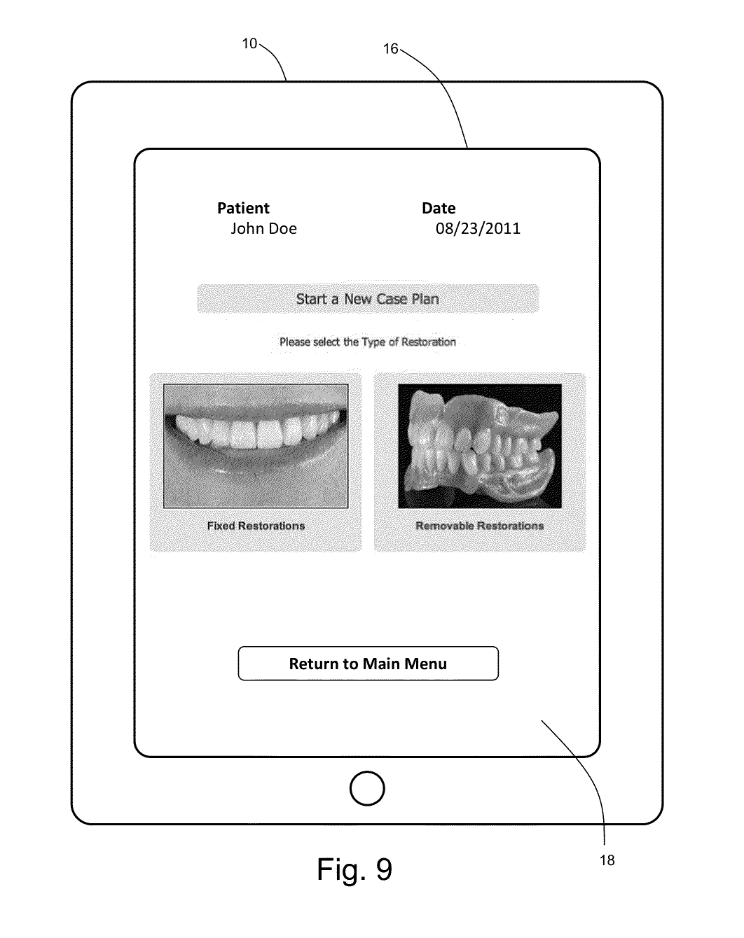

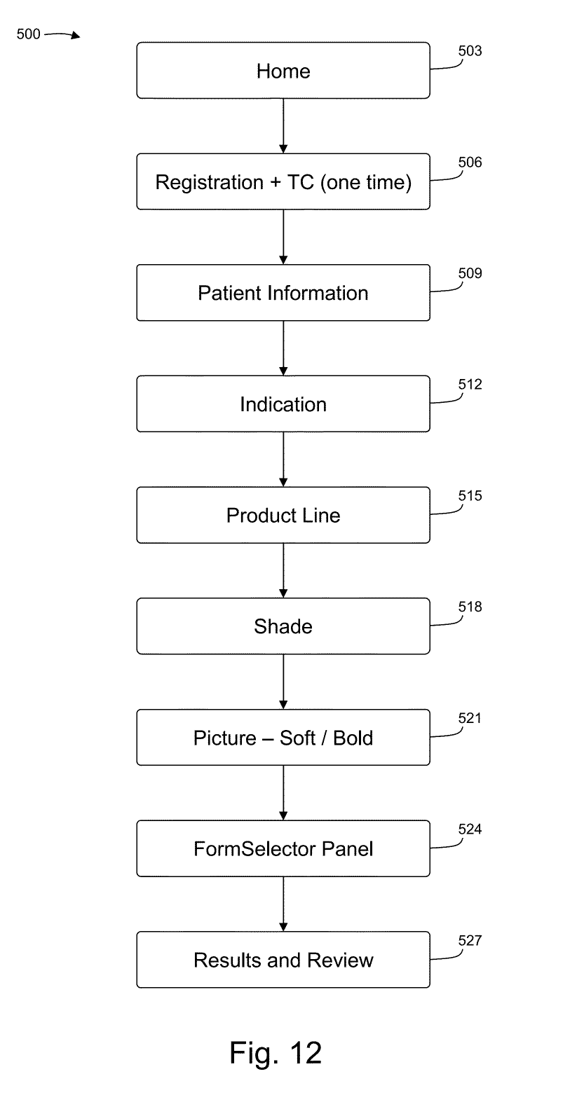

FIG. 12 depicts an exemplary method 500 which may be used to generate an order. In the exemplary method 500, a Home page is presented 503 to the operator wherein the operator may select from an existing case (see, e.g., FIG. 7) or create a new case. Upon first use, the operator may be requested to register 506 for access to the application and/or the database. The operator is prompted 509 for patient information. Such information may include name, age, gender, case identifier, due date of case, and the like. The operator is prompted 512 for the indication. For example, the operator may be prompted 512 to select either a complete denture or a partial denture. The operator may be prompted 512 to select either a fixed restoration or a removable restoration (see, e.g., FIG. 9). The operator is prompted 515 to select the appropriate product line (see, e.g., FIG. 10). The product line prompt may allow the user to select a product line for more information. For example, selecting a “Product Information” prompt may provide the operator with detailed technical information, marketing information, application information, or any other suitable information. The additional information may be presented in any format. For example, the additional information may include videos of the product, technical diagrams, audio information, links to web information, etc. The operator is prompted 518 to select a shade for each tooth of the case. The shades may be determined for each tooth independently or in any combination. The shade selection may include characteristics such as opacity, color, multiple shading layers, etc.

The operator is prompted 521 to select a characteristic of the tooth form. For example, the operator may be prompted to select from a boldness-softness range. The operatory may be presented with an image (picture) of the patient to aid in the selection. The operator is prompted 524 to select the mould for use in the case from a FormSelector panel. The mould and tooth form selections (corresponding to steps 521 and 524) may utilize the same presentation to the operator (see, e.g., FIG. 8). The operator is presented 527 with a results panel for review and/or revisions to the case plan. The case plan order may be generated as described above.

Any or all of the display screens (panels) of embodiments of the present invention may offer the operator the ability to obtain more information on the subject matter of the display screen. For example, the operatory may be able to click on an option for more information on tooth shade. Such information may offer guidance and best practices information on how to select shade, the latest academic papers and research on the subject, news regarding the latest shade technology, etc. Other information may enable the operator to visualize the tooth shade within an image of the patient. Additionally, the operator may be permitted, at any or all steps of the process, to enter additional notation for the laboratory technician to consider and/or use in manufacturing the case.

Although the present invention has been described with respect to one or more particular embodiments, it will be understood that other embodiments of the present invention may be made without departing from the spirit and scope of the present invention. There are numerous embodiments of the invention described herein including examples, all of which are intended to be non-limiting examples (whether explicitly described as non-limiting or not). Hence, the present invention is deemed limited only by the appended claims and the reasonable interpretation thereof.

What is claimed is:

1. A method of generating an order for a dental restoration of an individual, the method comprising the steps of:
(a) providing an automated tooth selection apparatus having:
(1) an image capture device for capturing an image of at least a portion of the individual;
(2) a processor in electronic communication with the image capture device; and
(3) wherein the image capture device captures range data corresponding to the distance between the image capture device and the individual;
(b) capturing an image of at least a facial feature of the individual using the image capture device;
(c) determining, using the processor, the size of the facial feature of the individual from the captured image and the corresponding range data;
(d) selecting a tooth from a database of available teeth based on at least the size of the facial feature of the individual; and
(e) generating, using the processor, the order for a dental restoration including the selected tooth.

2. The method of claim 1, wherein the step of selecting a tooth from the database of available teeth comprises the sub-steps of:
(a) selecting, using the processor, a set of candidate teeth from the database based on the size of the facial feature of the individual;
(b) displaying a visual depiction of each tooth of the set of candidate teeth on a display;
(c) prompting an operator to select a tooth from the set of candidate teeth; and
(d) receiving, using the processor, a tooth selection from an input device.

3. The method of claim 2, wherein the input device is a touch screen of the display.

4. The method of claim 3, wherein the automated tooth selection apparatus is a tablet computer having a camera.

5. The method of claim 1, wherein the facial feature is the interalar width of the individual's nose.

6. The method of claim 1, wherein the facial feature is the distance between the inner canthi of the eyes of the individual.

7. The method of claim 1, wherein the step of selecting a tooth from the database of available teeth comprises the sub-steps of:
(a) prompting an operator to select the tooth location of the dental restoration; and
(b) receiving, using the processor, a tooth location selection from an input device.

8. The method of claim 1, wherein the range data comprises an image of a calibration object placed proximate to the facial feature.

9. The method of claim 8, wherein the image of the facial feature further comprises the image of the calibration object.

10. The method of claim 1, wherein the automated tooth selection apparatus further comprises a rangefinder for determining the range data.

11. The method of claim 10, wherein the rangefinder comprises a target projector configured to project light onto the individual, and wherein the range data is derived from the projected target.

12. The method of claim 1, further comprising the steps of:
(a) prompting an operator to select a tooth color from a set of available tooth colors;
(b) receiving, using the processor, a tooth color selection from an input device; and
wherein the order includes the selected tooth color.

13. The method of claim 12, wherein the step of prompting an operator to select a tooth color further comprises the sub-step of displaying a visual depiction of each available tooth color on a display.

14. The method of claim 1, further comprising the steps of:
(a) prompting an operator to enter identifying information of the individual;
(b) receiving, using the processor, the identifying information of the individual from an input device; and
wherein the order includes the identifying information.

15. The method of claim 1, further comprising the steps of:
(a) prompting an operator to select a tooth material from a set of available tooth materials;
(b) receiving, using the processor, a tooth material selection from an input device; and
wherein the order includes the selected tooth material.

16. The method of claim 1, wherein the tooth is an anterior tooth.

17. The method of claim 1, wherein the step of generating the order including the selected tooth further comprises the sub-step of electronically transmitting the order to a dental restoration laboratory.

18. The method of claim 1, wherein the step of generating the order including the selected tooth further comprises the sub-step of printing the order on a printer.

19. A system for generating an order for a dental restoration of an individual, the system comprising:
(a) an automated tooth selection apparatus having:
(1) an image capture device for capturing an image of at least a facial feature of the individual;
(2) a processor in electronic communication with the image capture device; and
(3) wherein the image capture device captures range data corresponding to the distance between the image capture device and the individual;
(b) a database of available teeth; and
(c) wherein the processor is programmed to:
(1) determine the size of the facial feature of the individual from the captured image and the range data;
(2) select a tooth from the database of available teeth based on at least the size of the facial feature; and
(3) generate the order for a dental restoration of the selected tooth.

20. A computer-readable medium containing program instructions for generating an order for a dental restoration of an individual, the program for execution on an automated tooth selection apparatus having an image capture device and a processor, wherein the image capture device captures range data corresponding to the distance between the image capture device and the individual, and wherein execution of the program instructions by the processor of the automated tooth selection apparatus causes the processor to carry out the steps of:
(a) capturing an image of at least a facial feature of the individual using the image capture device;
(b) determining the size of the facial feature of the individual from the captured image and the corresponding range data;
(c) selecting a tooth from a database of available teeth based on at least the size of the facial feature; and
(d) generating the order including the selected tooth.
